(19) United States
(12) Patent Application Publication
(10) Pub. No.: US 2002/0007533 A1
(43) Pub. Date: Jan. 24, 2002

(54) Cinch and lock device

(76) Inventor: D. Scott Welch, Tucson, AZ (US)

Correspondence Address: D. SCOTT WELCH, 10825 E. ESCALANTE ROAD, TUCSON, AZ, 85730-5503, US

(21) Appl. No.: 09/908,756

(22) Filed: Jul. 19, 2001

Related U.S. Application Data
(60) Provisional application No. 60/219,580, filed on Jul. 20, 2000.

(51) Int. Cl. F16L 33/00

(52) U.S. Cl. 24/18

(57) ABSTRACT

The Cinch and Lock Device accomodates moderate-sized fabric-rope, cord, belt and bungee-cords. A feed-through cavity with an angled-ramp provide the base elements for the hand-actuated lever-arm to position an eccentric-motioned pressure-wheel. The lever-arm is spring-loaded to hold a closed pressure-lock position on a resident cord or belt. The lever-arm is hand-squeezed to allow non-obtsructed passage of a cord or belt through the cavity. With the desired cord or belt tension achieved, the spring-loaded lever-arm is released to the pressure hold condition. Typical applications of the Cinch and Lock device Include securing moderate-sized items such as office or home furniture items, including tarps.

### BACKGROUND OF THE INVENTION

1. Field of the Invention

This invention relates to the field of hand-operated cinching and securing devices applied to fabric-rope, bungee-cords and/or belts to aid the firm securing of items readied for transport or stowage.

2. Description of the Prior Art

There have been many cable, chain and belt cinching, locking and release devices presented over the time of U.S. Patent processing. They have provided a variety of methods to the securing or tie-down of collective or compiled items for safe and orderly transport or stowage. These devices range in duty requirements and application. They have been generally applied to heavy equipment as securing and tie-down devices employing high strength steel cable and chain. Light-duty cinch and locking devices that have been presented provide limited specific function conditions and applications for varied cord, belt or rope configurations.

### BACKGROUND OF THE INVENTION

One example of a limited applications device is disclosed in U.S. Pat. No. 6,049,950 issued to Cavallo. This device is by statement and configuration limited in application to BUNGEE cords. Additionally, the device requires application of at least two cord segments to be operational. One segment is pinned in the device. An opposing cord segment is slide-engaged to a serrated locking mechanism. By application to repeated load conditions, this device will degrade the strength integrity of both BUNGEE cord segments.

Another example is disclosed in U.S. Pat. No. 5,802,679 issued to Neeley. The Circular Cleat Apparatus device is limited in application, by internal radial cleats, to round cord shapes. It is also limited to assembly and disassembly to cords without attached hardware. It is limited by, configuration, in accommodating long lengths of cord that are often residual to the cord cinching and locking process. This apparatus is further limited by complexity and non-obvious visual reference to application.

A limited example is disclosed in U.S. D397,029 issued to Preuss. Limited by design category and title this configuration appears to be adaptable to a feed-through rope application. As a Design Patent, there is no disclosure of mechanical advantages that would ensure positive and repeated, cinch, lock and release applications.

Another example is disclosed in U.S. Pat. No. 4,887,337 issued to Bateman. This device is limited to round cord or rope. The cord feeds through a tight loop and complex mechanism that offers limited provision for incremental adjustment. It is further limited in adaptability by a fixed-loop cord attachment opposite the complex cord feed-through appliance.

Another example is disclosed in U.S. Pat. No. 4,592,116 issued to Christensen. Limited to cord or rope configuration this compression plate device is cam-lever actuated. This limits the cinching application to a course incremental process. Other limitations exist in terms of manipulation of multiple parts and non-obvious visual understanding of functions.

### SUMMARY OF INVENTION

Disadvantages inherent to known devices have been outlined. The need for this multipurpose device has been pronounced. The present invention has been developed with diligent consideration toward satisfying these major function conditions: 1) Offer a fast and easy method to apply cords or belts about light-to-moderate-weight items gathered for transport or stowage; 2) provide a device that will allow a simple hand-operated method of cinching, locking, holding cords or belts until desired to be quick released; 3) provide a device that is single-person actuated through cinching, locking and releasing functions; and 4) Be safe, light-weight, inexpensive and positive in promotional ease of application.

### DRAWING DESCRIPTIONS

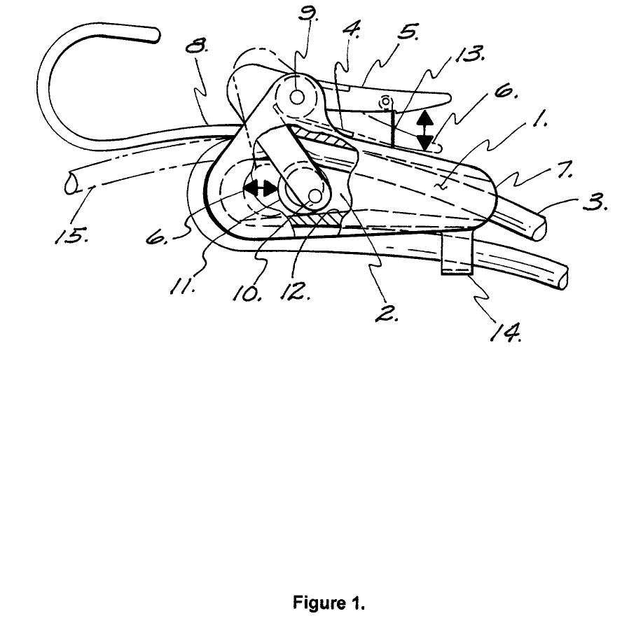

Drawing FIG. 1. A drawing profile view is provided with a cutaway portion displaying the engagement and disengagement features of the Cinch and Lock Device.

This device has a metal and/or plastic structural housing (1) with a feed-through cavity (2) allowing the passage of a cord or belt (3). A spring-loaded (4), lever-arm (5) is squeeze-positioned (6) to provide a clear passageway to feed a cord or belt (3) through the cavity (2). The cord or belt is fed through the small, non-hook end (7), and out through the opposite end with the hook (8). With a desired Cinch and Lock position obtained, the lever-arm (5) is released to rotate about the pivot-pin (9). This promotes the wheel axle (10) to press the oversized pressure-wheel (11) to rise-up the angled-ramp (12) to an eccentric lock condition to the cord or belt (3). A lock-pin (13) can then be rotated down from the lever-arm to secure the position. The pull end of the subject cord or belt (3) can be fed back through a retainer loop (14) or project freely (15) at the hook end of the device.

What is claimed is:

1. A unique hand-held and actuated device consisting of:
a metal or plastic housing structure;
a feed-through cavity with an angled ramp;
a metal or plastic outward projecting holding-hook;
a spring-loaded, hand-operable lock and release lever-arm;
a pivot pin to secure the lever-arm in lock position;
a pressure wheel with eccentric pressure motion;
a compact device that is uniquely multi-functional.

2. The combination Cinch and Lock Device of claim 1, wherein the lever-arm is hand-squeezed to present an open cavity.

3. The combination Cinch and Lock Device of claim 1, wherein a cord or belt can be fed through the open cavity.

4. The combination Cinch and Lock Device of claim 1, wherein a projecting holding-hook is positioned for fast secure attachment.

5. The combination Cinch and Lock Device of claim 1, wherein a released lever-arm promotes the pressure wheel to apply a grip-lock to a subject cord or belt by rising-up the angled ramp of the cavity.

6. The combination Cinch and Lock Device of claim 1, wherein the lock-pin can be deployed to secure the grip-lock condition.
